(19) United States
(12) Patent Application Publication
(10) Pub. No.: US 2015/0381886 A1
(43) Pub. Date: Dec. 31, 2015

(54) Camera Controlling Apparatus For Controlling Camera Operation

(71) Applicant: Casio Computer Co., Ltd., Shibuya-ku (JP)

(72) Inventors: Hiroyuki KATO, Fussa-shi (JP); Shohei Sakamoto, Fussa-shi (JP); Hideaki Matsuda, Adachi-ku (JP)

(73) Assignee: Casio Computer Co., Ltd., Tokyo (JP)

(21) Appl. No.: 14/661,873

(22) Filed: Mar. 18, 2015

(30) Foreign Application Priority Data
Jun. 30, 2014 (JP) 2014-133766

(51) Int. Cl. H04N 5/232

(52) U.S. Cl. CPC H04N 5/23222; H04N 5/23225

(57) ABSTRACT

A camera apparatus on an imaging terminal side detects the installation state (imaging state) of its own camera based on sensor information obtained by an imaging state sensor of the camera, and specifies the state as an imaging condition thereof. Then, the camera apparatus refers to a task table and thereby specifies a camera task associated with the installation state (imaging state) which is the imaging condition as a task of its own camera.

### CROSS-REFERENCE TO RELATED APPLICATION

This application is based upon and claims the benefit of priority from the prior Japanese Patent Application No. 2014-133766, filed Jun. 30, 2014, the entire contents of which are incorporated herein by reference.

### BACKGROUND OF THE INVENTION

1. Field of the Invention

The present invention relates to a camera controlling apparatus for controlling camera operation.

2. Description of the Related Art

Conventionally, as a camera system that captures still images or moving images of a single object from a plurality of different viewpoints by using a plurality of camera apparatuses (for example, digital cameras or camera-equipped portable devices), for example, a golf-swing analyzing system that captures images of the posture of an object (golfer) during a golf swing, the head position of a golf club, etc. and analyzes the images thereof is known (see Japanese Patent Application Laid-Open (Kokai) Publication No. 2010-130084). In such a golf-swing analyzing system, a plurality of camera apparatuses are structured to be installed at predetermined positions so as to surround an object (golfer).

### SUMMARY OF THE INVENTION

In accordance with one aspect of the present invention, there is provided a camera controlling apparatus comprising: a defining section which defines mutually different imaging conditions in advance for a plurality of tasks related to image capturing; a first specifying section which specifies an imaging condition of a role camera serving as a candidate to take one of the plurality of tasks; and a second specifying section which specifies a task of the role camera from among the plurality of tasks defined by the defining section, based on the imaging condition specified by the first specifying section.

In accordance with another aspect of the present invention, there is provided a camera controlling method for controlling operation of each of role cameras taking one of a plurality of tasks related to image capturing via a communicating section, comprising: a step of receiving and acquiring an imaging condition from each of the role cameras via the communicating section; and a step of specifying a task of each of the role cameras from among the plurality of tasks defined, based on the imaging condition of each of the role cameras received and acquired with mutually different imaging conditions being defined in advance for the plurality of tasks related to image capturing.

In accordance with another aspect of the present invention, there is provided a non-transitory computer-readable storage medium having a program stored thereon that is executable by a computer of a camera controlling apparatus to actualize functions comprising: processing for specifying an imaging condition of a role camera taking one of a plurality of tasks related to image capturing; and processing for specifying a task of the role camera from among the plurality of tasks defined, based on the imaging condition specified with mutually different imaging conditions being defined in advance for the plurality of tasks.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing basic components of a camera system (golf-swing analyzing system) provided with a plurality of camera apparatuses (camera controlling apparatus) 1;

FIG. 2 is a block diagram showing basic components of the camera apparatus 1;

FIG. 3 is a drawing showing part of a task table 13C provided in the camera apparatus 1;

FIG. 4 is a drawing showing the other part of the task table 13C subsequent to FIG. 3;

FIG. 5 is a flowchart showing operation (characteristic operation of a first embodiment) of the camera apparatus 1;

FIG. 6 is a flowchart for describing details of Step S4 of FIG. 5 (processing on an operation terminal side) executed when the camera apparatus 1 functions as an operation terminal;

FIG. 7 is a flowchart for describing details of Step S5 of FIG. 5 (processing on an imaging terminal side) executed when the camera apparatus 1 functions as an imaging terminal;

FIG. 8A to FIG. 8D are diagrams showing display examples of a case in which images captured by the side of imaging terminals are transmitted to the operation terminal side and displayed in parallel in a terminal screen thereof;

FIG. 9 is a flowchart for describing details of Step S5 of FIG. 5 (processing on an imaging terminal side) in a second embodiment; and

FIG. 10 is a flowchart for describing details of Step S4 of FIG. 5 (processing on an operation terminal side) in the second embodiment.

### DETAILED DESCRIPTION OF THE PREFERRED EMBODIMENTS

Hereinafter, embodiments of the present invention will be described in detail with reference to the drawings.

### First Embodiment

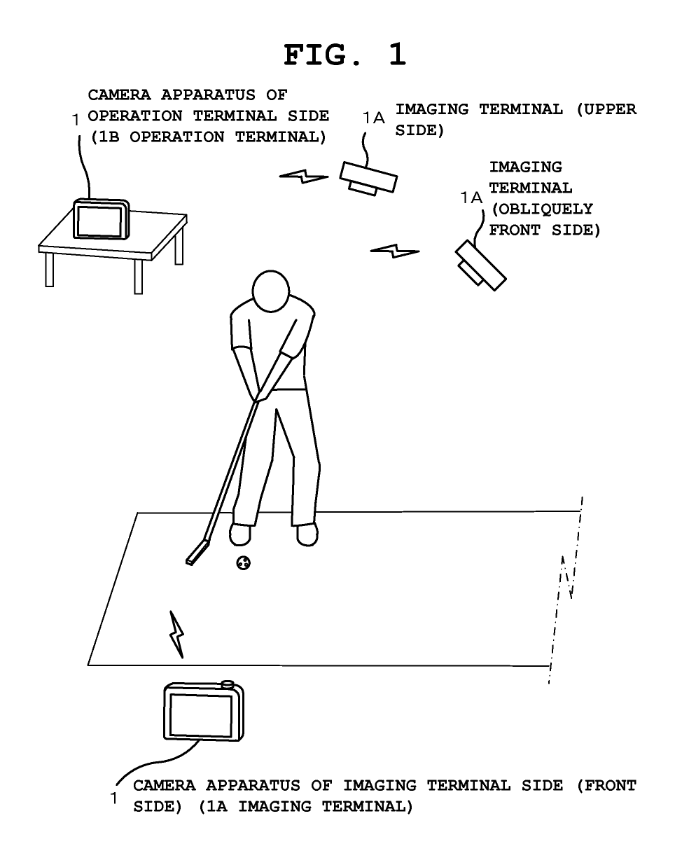

First, a first embodiment of the present invention is described with reference to FIG. 1 to FIGS. 8A to 8D.

The present embodiment is an example where the present invention has been applied in a camera system (golf-swing analyzing system) for analyzing, for example, the posture and the head position of a golf club during a golf swing practice by capturing images of a single object (for example, a golfer) from a plurality of different viewpoints by a plurality of camera apparatuses installed in the interior of, for example, a golf practice range. FIG. 1 is a block diagram showing basic components of this camera system (golf-swing analyzing system).

This camera system (golf-swing analyzing system) is structured to have a plurality of camera apparatuses (imaging apparatus) 1. Among the plurality of camera apparatuses 1, the camera apparatuses 1 which are arranged around the object during a golf practice and capture images from mutually different viewpoints serve as an imaging terminal side, the other camera apparatus 1 serves as an operation terminal side. Hereinafter, the camera apparatuses 1 of the imaging terminal side will be simply referred to as imaging terminals 1A, and the camera apparatus 1 of the operation terminal side will be simply referred to as an operation terminal 1B. The imaging terminals 1A and the operation terminal 1B can be mutually connected via wireless communication (for example, short-distance communication). The imaging terminals 1A and the operation terminal 1B may be dedicated cameras, respectively. However, in the present embodiment, both of them have identical structures, the operation terminal 1B can be used as the imaging terminal 1A, and, reversely, the imaging terminal 1A can be used as the operation terminal 1B. Therefore, in a case in which both of them are not distinguished from each other, each of them is simply referred to as a camera apparatus or a camera controlling apparatus 1.

The camera apparatus (camera controlling apparatus) 1 is a digital compact camera provided with an imaging function (camera function) capable of capturing still images and capturing moving images. The camera apparatus 1 is provided with an imaging function capable of capturing images of objects at high definition and basic functions such as an image playback function of arbitrarily reading out and replaying captured images which have been recorded and stored (stored images). In addition, particularly, in the present embodiment, the camera apparatus 1 is provided with a special imaging function (coordinated imaging function) of simultaneously capturing images of a single object (for example, a golfer or a ball) from a plurality of mutually different viewpoints by the plurality of coordinated camera apparatuses 1. The camera apparatus 1 is not limited to a compact camera, but may be a single-lens reflex camera. The camera apparatus 1 is attachable to fixing equipment (illustration omitted) such as a tripod. This fixing equipment is structured to be able to change an imaging position (the installed position of the camera) by moving the fixing equipment and able to arbitrarily change an imaging direction (optical-axis direction of the camera) and an imaging height (camera-installed height). For example, the fixing equipment can be installed to be horizontally upright on a floor surface or can be installed by being attached to a ceiling surface, a lateral wall, etc.

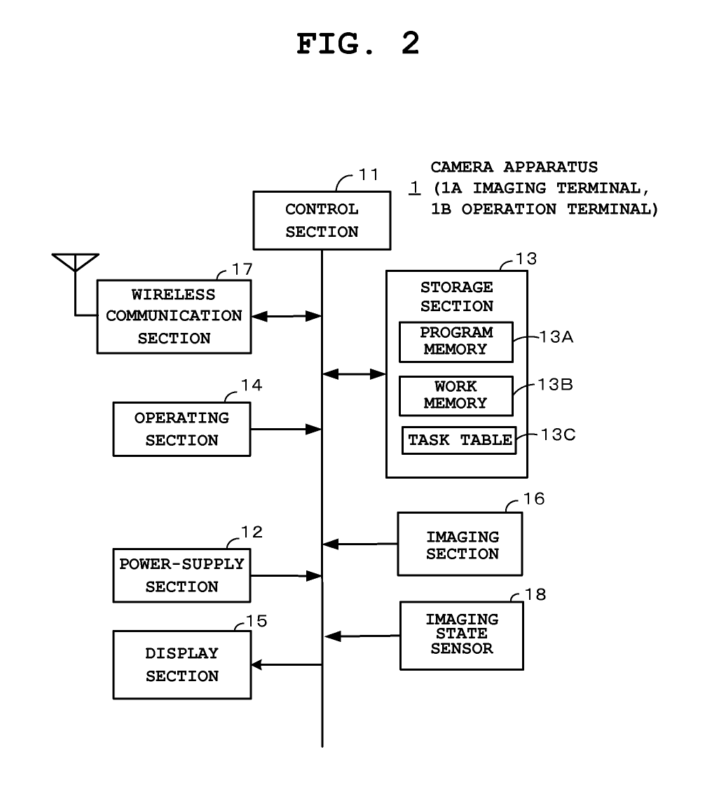

FIG. 2 is a block diagram showing basic components of the camera apparatus 1.

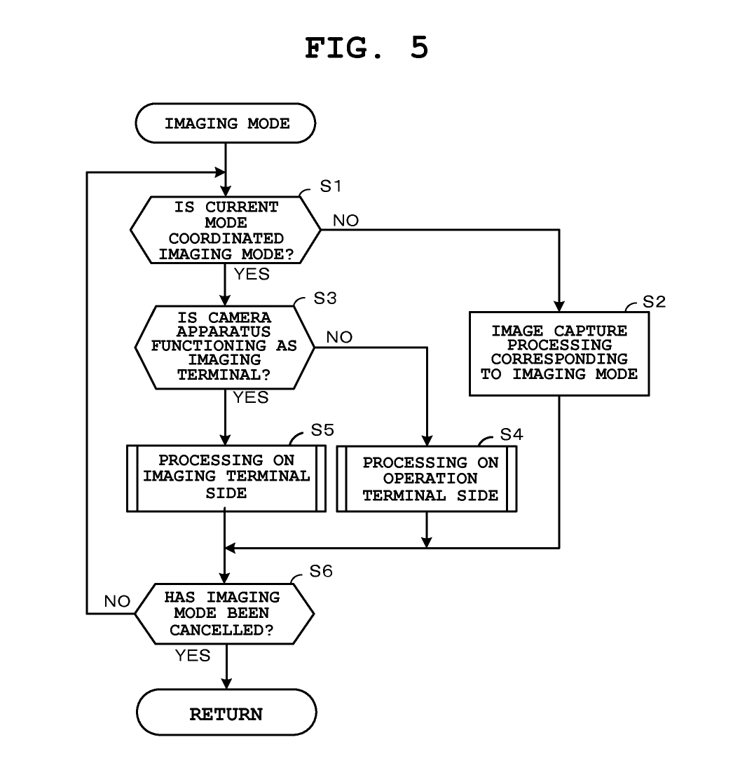

A control section 11 serving a core of the camera apparatus 1 is operated by power supply from a power supply section (secondary battery) 12 and controls the overall operation of the camera apparatus 1 in accordance with various programs stored in a storage section 13. The control section 11 is provided with a CPU (Central Processing Unit), a memory, and the like not shown. The storage section 13 is configured to have a ROM (Read-Only Memory), a flash memory, etc. The storage section 13 has a program memory 13A which stores a program(s), various applications, etc. for realizing the present embodiment in accordance with later-described operation procedures shown in FIG. 5 to FIG. 7, a work memory 13B which temporarily stores a flag and the like, a later-described task table 13C, and the like. Note that the storage section 13 may be structured to include, for example, a removable portable memory (recording medium) such as an SD (Secure Digital) card or an IC (Integrated Circuit) card and, although not shown, may be structured to include a storage region on a predetermined server device side in a state where the storage section 13 is connected to a network via a communication function.

An operating section 14 is provided with push-button-type various keys not shown. The operating section 14 is provided with, for example, a mode changing button for switching between an imaging mode and a playback mode in which captured images (saved images) are replayed, and for switching to, for example, a coordinated imaging mode of the imaging mode in which the above described special imaging function (coordinated imaging function) is enabled; a release button for giving an image capturing instruction; a zoom lever for adjusting a view angle (zoom); a setting button for setting imaging conditions such as exposure and a shutter speed; etc. The control section 11 executes, for example, mode changing processing, imaging condition setting processing, etc. as processing corresponding to input operation signals from the operating section 14.

A display section 15 has, for example, a high-definition liquid-crystal screen having mutually-different vertical/horizontal ratios, and the screen serves as a monitor screen (live view screen) for displaying captured images in real time (live view images), or serves as a playback screen for replaying captured images. An imaging section 16 constitutes a camera section (imaging function) which can capture images of an object at high definition, and has functions of zoom adjustment, focal-point adjustment, automatic exposure adjustment (AE), automatic focal-point adjustment (AF), etc. When an object image from an optical lens system is formed on an imaging element in the imaging section 16, photo-electrically-converted and read image signals (analog-value signals) are converted to digital-value data, converted to data of a screen size of the display section 15, and displayed as a live view image in real time. Then, when an instruction to perform image capturing is given by the release button, a captured image is subjected to processing related to white balance, sharpness, etc., subjected to compression processing, and recorded and stored in the storage section 13 (for example, SD card).

In the above-described coordinated imaging mode, a wireless communication section 17, which performs wireless communication with the plurality of other camera apparatuses 1, can perform, for example, short-distance wireless communication (for example, Bluetooth (registered trademark)) or communication by wireless LAN (Local Area Network: WI-Fi) connection. More specifically, wireless communication is performed between the imaging terminals 1A and the operation terminal 1B, in which each of the imaging terminals 1A performs image capture processing in accordance with an image capturing instruction from the operation terminal 1B, and the captured images thereof are transmitted to the operation terminal 1B and displayed in parallel in a terminal screen thereof. The communication means between the imaging terminals 1A and the operation terminal 1B may be optical communication, wired connection, etc.

As various sensors (illustration omitted), an imaging state sensor 18 includes an acceleration sensor (gradient sensor) for specifying an imaging direction (vertical gradient) by detecting the posture of the camera in the coordinated imaging mode, in other words, the angle of the optical-axis direction of the camera apparatus 1 with respect to the direction of gravity (vertical gradient); a magnetic sensor (electronic compass) for specifying the imaging direction (orientation) at high definition (for example, in 10° unit) by detecting minute geomagnetism; and an atmospheric-pressure sensor (altimeter) for specifying an imaging height (high or low with respect to a reference height) at high definition (for example, in 2-meter unit) by detecting changes in the atmospheric pressure. Based on the detection results of the imaging state sensor 18, in other words, the detection results of the acceleration sensor, the magnetic sensor (electronic compass), and the atmospheric-pressure sensor (altimeter), the imaging terminal 1A refers to its task table 13C so as to specify an installation state (imaging state) thereof as the imaging conditions in the coordinated imaging mode.

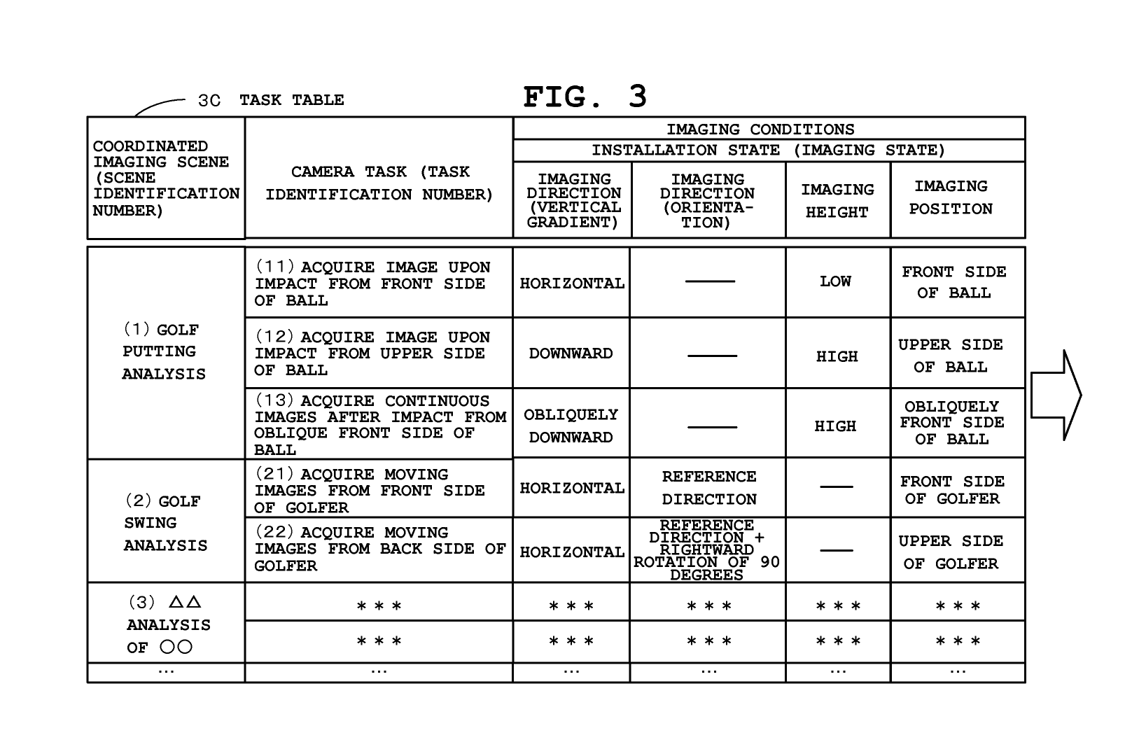

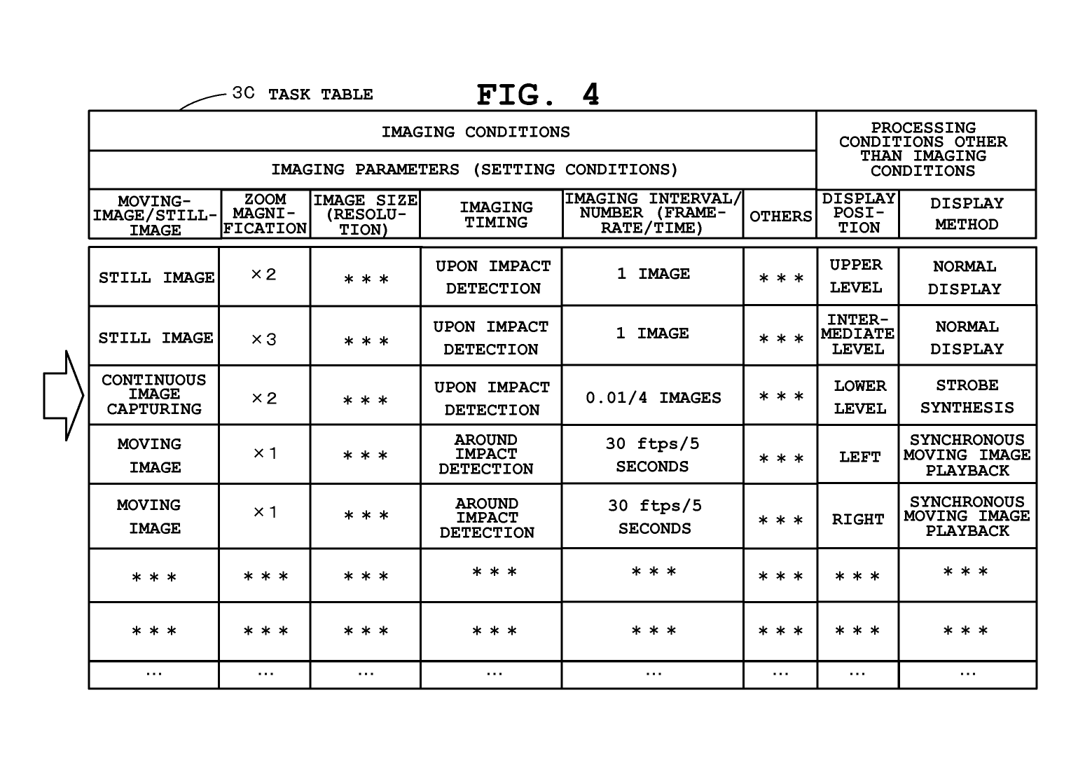

FIG. 3 and FIG. 4 are drawings for describing the task table 13C. FIG. 3 shows part of the task table 13C, and FIG. 4 is a diagram showing the other part of the task table 13C subsequent to FIG. 3.

The task table 13C is a table used in the coordinated imaging mode in which the plurality of camera apparatuses 1 are coordinated to simultaneously capture images of a single object (for example, golfer) from a plurality of mutually different viewpoints and is a table for defining a plurality of tasks related to image capturing and different imaging conditions, etc. for each of the plurality of tasks in advance. As shown in FIG. 3 and FIG. 4, the task table 13C is configured to have fields of “coordinated imaging scenes”, “camera tasks”, “imaging conditions”, and “processing conditions other than imaging conditions”.

The “coordinated imaging scenes” show the imaging scenes for capturing images of golf swings by different scenes and, in the example shown in the drawings, scene-based identification numbers (1), (2), (3), etc thereof are stored corresponding to “golf putting analysis”, “golf swing analysis”, “other analysis”, etc. The “camera tasks” show the tasks (tasks related to image capturing) allocated to the plurality of camera apparatuses 1 separately in “coordinated imaging scenes”. In the example shown in the drawings, in the case in which the “coordinated imaging scene” is “golf putting analysis”, in other words, in the case in which the scene identification number is (1), task identification numbers (11), (12), and (13) are stored corresponding to the tasks of “acquire image upon impact from front side of ball”, “acquire image upon impact from upper side of ball”, and “acquire continuous images after impact from obliquely front side of ball”. In the case in which the scene identification number is (2), task identification numbers (21) and (22) are stored corresponding to the tasks “acquire moving images from front side of golfer” and “acquire moving images from back side of golfer”.

Corresponding to the respective “camera tasks” of each of the “coordinated imaging scenes”, the task table 13C has the fields of “imaging conditions” showing the arranged state and imaging parameters of the camera apparatus 1. The “imaging conditions” show various conditions for performing coordinated image capturing and are separated into the fields of “installation state (imaging state)” serving as the conditions of installing the camera apparatus 1 upon the coordinated image capturing and “imaging parameters (setting conditions)” as the conditions set upon the coordinated image capturing. The “installation state (imaging state)” has the fields of “imaging direction (vertical gradient)”, “imaging direction (orientation)”, “imaging height”, and “imaging position”. The “imaging direction (vertical gradient)” shows the angle of the optical-axis direction of the camera with respect to the direction of gravity (vertical gradient). In the example shown in the drawings, in the case in which the scene identification number is (1), “horizontal”, “downward”, and “obliquely downward” are stored corresponding to the task identification numbers (11), (12), and (13),respectively. In the case in which the scene identification number is (2), “horizontal” is stored corresponding to each of the task identification numbers (21) and (22).

The “imaging direction (orientation)” shows the angle (orientation) of the optical-axis direction of the camera apparatus 1 with respect to a reference orientation (for example, northward direction). In the drawing, “−” of the “imaging direction (orientation)” shows that no orientation is stored (any orientation may be used). In the case in which the scene identification number is (2), “reference orientation” and “reference orientation+rightward rotation of 90°” are stored corresponding to the task identification numbers (21) and (22). The “imaging height” shows whether the camera is high or low with respect to a reference height (for example, 2 m). In the example shown in the drawings, in the case in which the scene identification number is (1), “low”, “high”, and “low” are stored corresponding to the task identification numbers (11), (12), and (13), respectively. In the drawing, “−” of the “imaging height” shows that no height is stored (that any height may be used).

The “imaging position” shows the installation position of the camera apparatus 1 with respect to an object. In the example shown in the drawings, in the case in which the scene identification number is (1), “front side of ball”, “upper side of ball”, and “obliquely front side of ball” are stored corresponding to the task identification numbers (11) to (13), respectively. In the case in which the scene identification number is (2), “front side of golfer” and “back side of golfer” are stored corresponding to the task identification numbers (21) and (22), respectively. In the present embodiment, part of the tasks of the cameras conceptually includes the imaging positions. Accordingly, the field of “imaging position” is not particularly required to be provided, but the field of “imaging position” is provided in order to clearly state the correspondence to the tasks.

In this manner, in the case of “acquire image upon impact from front side of ball” which is the task of the task identification number (11), as the “installation state (imaging state)”, “horizontal” is stored as the “imaging direction (vertical gradient)”, “low” is stored as the “imaging height”, and “front side of ball” is stored as the “imaging position”, in order to execute the task. Meanwhile, in the case of “acquire image upon impact from upper side of ball” which is the task of the task identification number (12), “downward” is stored as the “imaging direction (vertical gradient)”, “high” is stored as the “imaging height”, and “upper side of the ball” is stored as the “imaging position”, in order to execute the task.

The “imaging parameters (setting conditions)” show part of the tasks related to image capturing, are the conditions set upon coordinated image capturing (imaging parameters), and have the fields of “moving-image/still-image”, “zoom magnification”, “image size (resolution)”, “imaging timing”, “imaging interval/number (frame-rate/time)”, and “others” as various imaging parameters. The “moving-image/still-image” shows whether the coordinated image capturing is moving-image capturing or still-image capturing In the example shown in the drawing, in the case in which the scene identification number is (1), “still image”, “still image”, and “continuous image capturing” are stored corresponding to the task identification numbers (11) to (13). In the case in which the scene identification number is (2), “moving image” is stored corresponding to each of the task identification numbers (21) and (22). The “zoom magnification” is the zoom magnification upon coordinated image capturing and is an image size upon coordinated image capturing of “image size (resolution)”.

The “imaging timing” shows the imaging timing upon coordinated image capturing. In the example shown in the drawings, in the case in which the scene identification number is (1), “upon impact detection” is stored corresponding to each of the task identification numbers (11), (12), and (13). Meanwhile, in the case in which the scene identification number is (2), “around impact detection” is stored corresponding to each of the task identification numbers (21) and (22). The “imaging interval/number (frame-rate/time)” shows the imaging interval or number of images (frame rate or time) upon coordinated image capturing. In the case in which the scene identification number is (1), “1 image”, “1 image”, and “0.01 second/4 seconds” are stored corresponding to the task identification numbers (11) to (13), respectively. Meanwhile, in the case in which the scene identification number is (2), “30 fps/5 seconds” is stored corresponding to each of the task identification numbers (21) and (22). Note that “others” are, for example, the presence/absence of strobe light emission.

The “processing conditions other than imaging conditions” show part of the tasks related to image capturing as well as “imaging parameters” and are the conditions for executing other processes excluding the above described imaging conditions. In the example shown in the drawings, the processing conditions of the case in which captured images are transmitted to and displayed by the operation terminal 1B are shown, and these conditions have the fields of “display position” and “display method”. The “display position” shows the display position of the case in which the captured image(s) is displayed in the screen of the operation terminal 1B and shows the position of the area in which the image is to be displayed among upper-level, intermediate-level, lower-level, right-side, and left-side areas in the terminal screen thereof.

In the example shown in the drawings, in the case in which the scene identification number is (1). “upper level”, “intermediate level”, and “lower level” are stored corresponding to the task identification numbers (11) to (13), respectively. In the case in which the scene identification number is (2), “left” and “right” are stored corresponding to the task identification numbers (21) and (22), respectively.

The “display method” shows a display method (normal display, strobe synthesis, synchronous moving image playback, etc.) of the case in which the captured image(s) is displayed in the screen of the operation terminal 1B. Note that the synchronous moving image playback is a display method of synchronously replaying a plurality of images (moving images) of parallel display. In the example shown in the drawings, in the case in which the scene identification number is (1), “normal display”, “normal display”, and “strobe synthesis” are stored corresponding to the task identification numbers (11) to (13), respectively. Meanwhile, in the case in which the scene identification number is (2), “synchronous moving image playback” is stored corresponding to each of the task identification numbers (21) and (22).

Next, the operational concept of the camera apparatus 1 in the first embodiment is described with reference to the flowcharts shown in FIG. 5 to FIG. 7. Here, each function described in the flowcharts is stored in a readable program code format, and operations based on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium. This applies to other embodiments described later. FIG. 5 to FIG. 7 are flowcharts outlining the operation of the characteristic portion of the present embodiment from among all of the operations of each camera apparatus 1. After exiting the flows of FIG. 5 to FIG. 7, the procedure returns to the main flow (omitted in the drawings) of the overall operation.

When the plurality of camera apparatuses 1 are to be arranged around an object (for example, golfer or ball) during a golf practice, the operation mode thereof is switched to the coordinated imaging mode by user operations and each camera apparatus 1 is specified to function as an imaging terminal. Then, the camera apparatuses 1 which function as imaging terminals are respectively arranged in, for example, the front side, the upper side, and the obliquely front side of the object such that the imaging directions thereof are directed toward the object. Also, a single camera apparatus 1 other than them is switched to the coordinated imaging mode and, in this process, specified to function as an operation terminal.

FIG. 5 is a flowchart showing the operations of the camera apparatus 1 (characteristic operations of the first embodiment), and the camera apparatus 1 starts the flowchart when switched to the imaging mode.

First, when switched to the imaging mode, the camera apparatus 1 judges whether the current mode is the above-described coordinated imaging mode (Step S1). If the current mode is not the coordinated imaging mode (NO at Step S1), the camera apparatus 1 proceeds to image capture processing (processing for capturing an image(s) independently by the individual camera apparatuses 1) corresponding to the imaging mode (Step S2). If the current mode is the coordinated imaging mode (YES at Step S1), the camera apparatus 1 judges whether the camera apparatus 1 has been specified by the user to function as the imaging terminal (Step S3).

Here, when the camera apparatus 1 has not been specified to be an imaging terminal (NO at Step S3), this is a case where the camera apparatus 1 has been specified by the user to function as an operation terminal. Therefore, the camera apparatus 1 proceeds to later-described camera processing (Step S4) on the operation terminal side. However, when the function of the imaging terminal has been specified (YES at Step S3), the camera apparatus 1 proceeds to later-described camera processing on the imaging terminal side (Step S5). Then, the camera apparatus 1 judges whether the imaging mode has been cancelled to instruct image capturing termination (Step S6). When the imaging mode is continued (NO at Step S6), the camera apparatus 1 returns to above described Step S1. When the imaging mode is cancelled (YES at Step S6), the camera apparatus 1 exits this flow of FIG. 5.

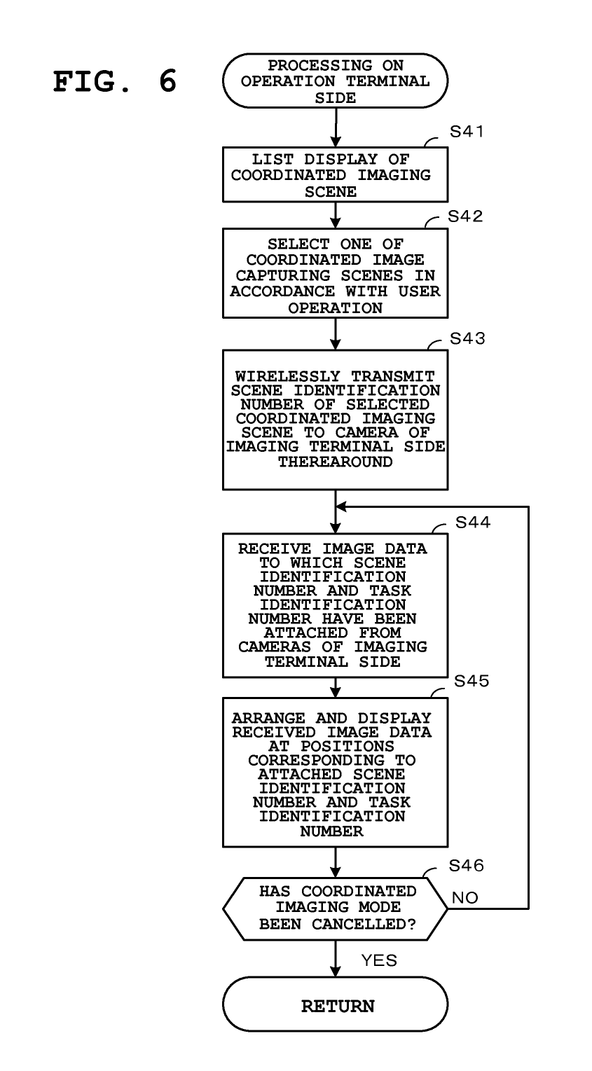

FIG. 6 is a flowchart for describing Step S4 (processing on the operation terminal side) of FIG. 5 in detail.

Even when the current mode has been switched to the above described coordinated imaging mode, the operation terminal 1B does not perform image capture processing, and performs wireless communication with each of the imaging terminals 1A. More specifically, in the state in which the contents of the “coordinated imaging scenes” of the task table 13C have been read and displayed as a list (Step S41), when any one of the “coordinated imaging scenes” is selected by a user operation (Step S42), the operation terminal 1B performs processing for wirelessly transmitting the selected “identification number of coordinated imaging scene” concurrently to the imaging terminals 1A (Step S43).

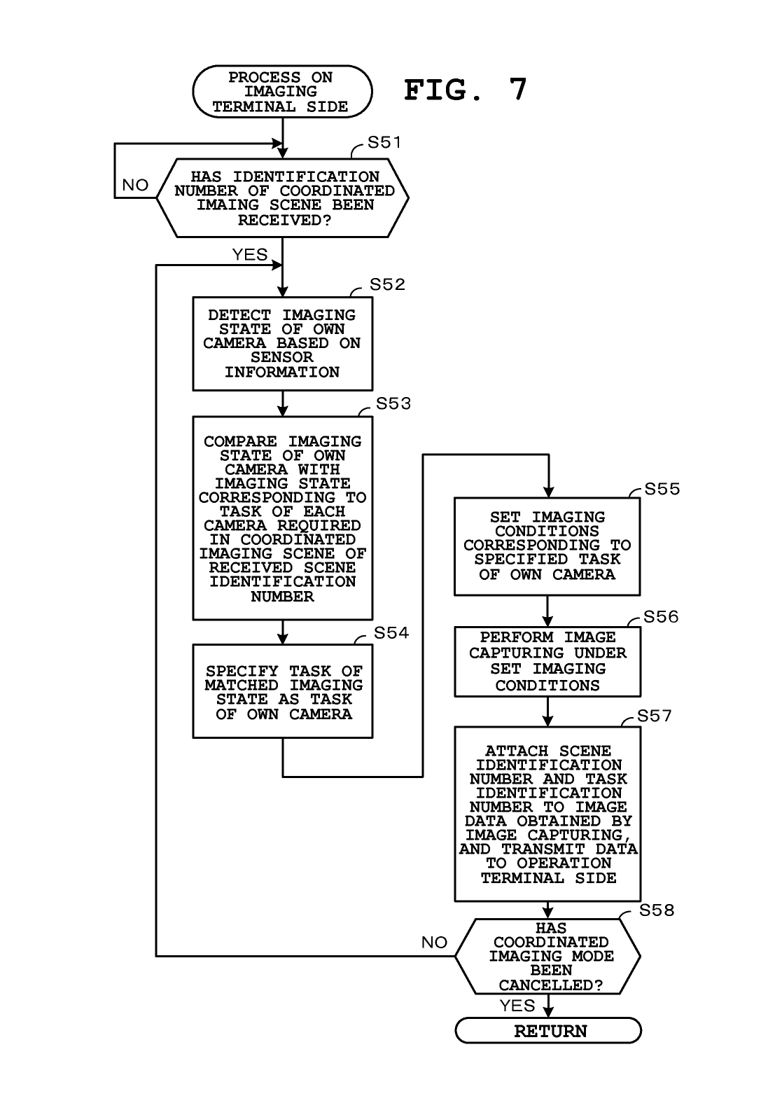

FIG. 7 is a flowchart for describing Step S5 (processing on the imaging terminal side) of FIG. 5 in detail.

When each of the imaging terminals 1A receives the “identification number of coordinated imaging scene” from the operation terminal 1B (YES at Step S51), the imaging terminal 1A performs processing for specifying the imaging conditions of a role camera that takes any of the plurality of tasks defined in the task table 13C to correspond to the “identification number of coordinated imaging scene” (Step S52). Note that the role camera is the imaging terminal 1A that is in charge of the task when coordinated image capturing is performed, and its own camera serves as the role camera in the present embodiment.

More specifically, the imaging terminal 1A specifies the installation state (imaging state) of its own camera as imaging conditions based on the sensor information obtained by the imaging state sensor 18 of its own camera (role camera). In this case, the detection results of the imaging state sensor 18, that is, the detection results of the acceleration sensor, magnetic sensor (electronic compass), and atmospheric-pressure sensor (altimeter) are specified as the installation state (imaging state), in other words, the imaging conditions of its own camera. Then, the task table 13C is subjected to search while using the “identification number of coordinated imaging scene” received from the operation terminal 1B as a key, and the “installation state (imaging state)” corresponding to each “camera task” of the corresponding “coordinated imaging scene” is compared with the installation state (imaging state) of its own camera detected by the imaging state sensor 18 (Step S53).

In this case, the field of the “imaging position” is stored the “installation state (imaging state)” of the task table 13C. However, the “imaging position” is not present in the detection results of the imaging state sensor 18. Therefore, in the processing of Step S53, the imaging terminal 1A compares the combination of the “imaging direction (vertical gradient)”, “imaging direction (orientation)”, and “imaging height” of the task table 13C with the detection results (the combination of the detection results of the acceleration sensor, the electronic compass, and the altimeter) of the imaging state sensor 18. Then, the imaging terminal 1A judges whether all of the fields match, as a result of comparing the combinations of the plurality of fields. If the field(s) in which “−” has been set in the task table 13C is present the imaging terminal 1A judges whether all of the other fields excluding that field(s) match.

Here, when all of the fields match, the imaging terminal 1A specifies the matched “installation state (imaging state)” as the imaging condition of a first field of its own camera and specifies the “camera task” associated with the “installation state (imaging state)” as the task of its own camera (Step S54). For example, when the “imaging direction (vertical gradient)” matches “horizontal” and the “imaging height” matches “low”, the imaging terminal 1A specifies the “installation state (imaging state)” as the imaging condition of the first field of its own camera and specifies “acquire image upon impact from front side of ball” as the “camera task” associated with the “installation state (imaging state)”.

Then, as the imaging conditions corresponding to the specified “camera task”, the imaging terminal 1A specifies the “imaging parameters (setting conditions)” in the task table 13C as a second field, and the imaging terminal 1A executes processing for reading out and setting the values of the “moving-image/still-image”, “zoom magnification”, “image size (resolution)”, “imaging timing”, “imaging interval/number (frame-rate/time)”, and “others” in the “imaging parameters (setting conditions)” (Step S55). Then, the imaging terminal 1A instructs the imaging section 16 to start image capturing under the conditions of the set “imaging parameters” (Step S56).

Note that the relation between the imaging condition of the first field and the imaging condition of the second field may be the relation between the imaging position and the imaging direction showing the imaging state related to installation of the imaging terminal 1A. More specifically, when the imaging condition of the first field is the imaging direction and the imaging condition of the second field is the imaging position, another imaging state “imaging position” may be specified as the second field based on the imaging condition (imaging direction) corresponding to the specified “camera task”.

The imaging terminal 1A records and stores the image data captured as described above in the storage section 3 of its own camera, attaches the “identification number of coordinated imaging scene” received from the operation terminal 1B and the specified “identification number of camera task” to the captured-image data, and transmits the data to the operation terminal 1B (Step S57). Then, the imaging terminal 1A judges whether the coordinated imaging mode has been cancelled to instruct termination thereof (Step S58). Here, until termination of the coordinated image capturing is instructed, the imaging terminal 1A repeatedly returns to above described Step S52 and performs the above described operations. When the termination of the coordinated image capturing is instructed (YES at Step S58) the imaging terminal 1A exists the flow of FIG. 7.

On the other hand, when the operation terminal 1B receives the captured image data from the imaging terminal 1A (Step S44 of FIG. 6), the operation terminal 1B searches the task table 13C by using the “identification number of coordinated imaging scene” and the “identification number of camera task” attached to the captured image data as keys, acquires “display position” and “display method” from the “processing conditions other than imaging conditions” associated with the “identification number of coordinated imaging scene” and the “identification number of camera task”, and displays the captured image(s) at a predetermined position(s) in the terminal screen thereof in accordance with the “display position” and the “display method” (Step S45). Then, the operation terminal 1B judges whether the coordinated imaging mode has been cancelled and the termination thereof has been instructed (Step S46). Here, until the termination of the coordinated image capturing is instructed, the operation terminal 1B repeatedly returns to above described Step S44 and, every time the captured-image data is received from each of the imaging terminals 1A, additionally displays (parallel display) the captured images in the terminal screen (Step S45). Here, when the termination of the coordinated image capturing is instructed (YES at Step S46), the operation terminal 1B exits the flow of FIG. 6.

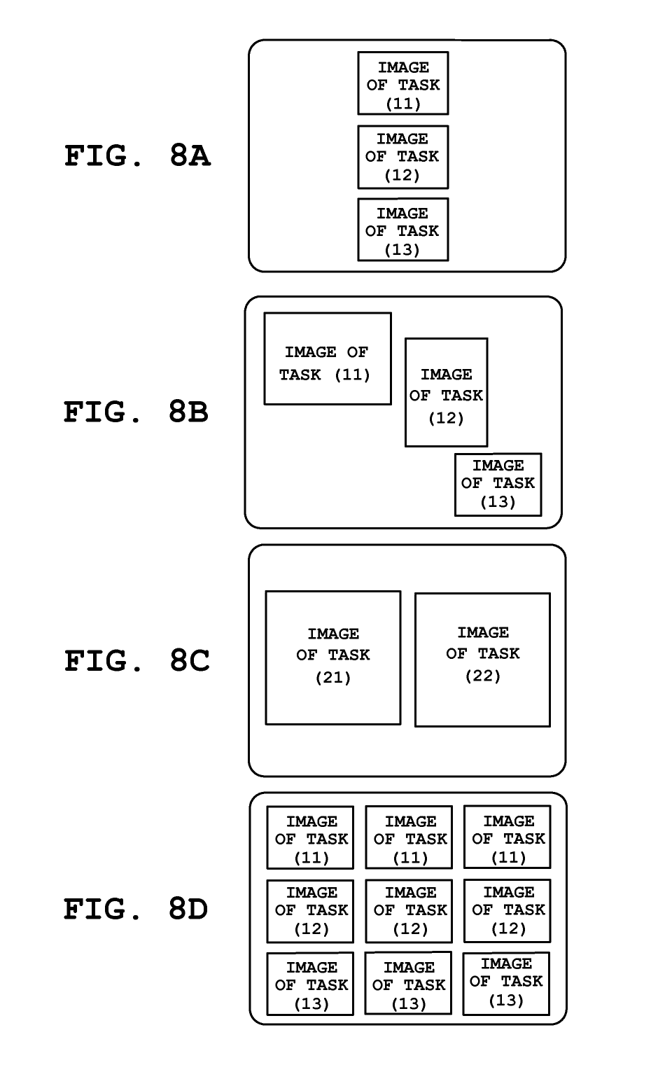

FIG. 8A to FIG. 8D are diagrams showing display examples when the images captured by the imaging terminals 1A have been transmitted to the operation terminal 1B and parallelly displayed on the terminal screen thereof.

FIG. 8A is a diagram showing the state where the scene identification number is (1) and the images of the tasks (11), (12), and (13) captured by the “imaging parameters” corresponding to the task identification numbers (11), (12), and (13) thereof have been parallelly displayed. In this case, in accordance with the “processing conditions other than imaging conditions” in the task table 13C corresponding to the scene identification number (1), the image of the task (11) is normally displayed in the upper level of the screen, and the image of the task (12) is normally displayed in the intermediate level of the screen. The image of the task (13) is strobe-synthesized four continuously-captured images displayed in the lower level of the screen.

FIG. 8B is a diagram showing a display example when the scene identification number is (1) as well as FIG. 8A, but the sizes of the captured images are mutually different. In this case, the images of the tasks (11) and (12) are large, and the images cannot be arranged and displayed in one vertical column. Therefore, this is a case in which the images have been parallelly displayed while being transversely shifted from each other and maintaining the relation of the upper level, the intermediate level, and the lower level. FIG. 8D shows the case in which the imagers of the tasks (11) to (13) have been arranged and displayed in vertical columns as those shown in FIG. 8A. In the drawing, the vertical column in the left side shows the images of the tasks (11) to (13) obtained in the image capturing of a first time, the intermediate vertical column shows the images of the tasks (11) to (13) obtained in the image capturing of a second time, and the vertical column in the right side shows the images of the tasks (11) to (13) obtained in the image capturing of a third time.

FIG. 8C is a diagram showing the state where the image of the task (22) captured according to the “imaging parameters” corresponding to the task identification numbers (21) and (22) of the case in which the scene identification number is (2) have been parallelly displayed. In this case, in accordance with the “processing conditions other than imaging conditions” in the task table 13C corresponding to the scene identification number (2), the image (moving image) of the task (21) is synchronously replayed in the left side of the screen, and the image (moving image) of the task (22) is synchronously replayed in the right side of the screen.

As described above, in the first embodiment, the imaging terminal 1A is configured to specify the imaging conditions of its own camera (role camera) which performs one of the plurality of tasks and, based on the imaging conditions, specify the task of its own camera from among the plurality of tasks defined in the task table 13C. Therefore, even when the imaging conditions of its own camera are changed, the task related to the image capturing can be adapted to the changed imaging conditions without requiring special operation, and operation control suitable for the task can be realized.

The plurality of tasks related to image capturing are the tasks which are allocated to the role cameras when image capturing is performed by coordination of the plurality of role cameras (cameras of the imaging terminal side) including its own camera, and the coordinated image capturing by the role cameras including its own camera becomes appropriate.

The task table 13C defines in advance the different combinations of the imaging conditions of the first field and the imaging conditions of the second field respectively with respect to the plurality of tasks related to image capturing, and the imaging terminal 1A is configured to specify the imaging condition of the first field of its own camera, specify the task of its own camera from among the plurality of tasks defined in the task table 13C based on the imaging condition of the first field, and specify the imaging condition of the second field corresponding to the task of its own camera from among the plurality of imaging conditions of the second field defined in the task table 13C based on the specified task. Therefore, the imaging terminal 1A can sequentially specify the imaging condition of the first field, the task, and the imaging condition of the second field of its own camera.

The relation between the imaging condition of the first field and the imaging condition of the second field is the relation between the imaging position and the imaging direction showing the imaging state related to the installation of its own camera. If either one of the imaging position and the imaging direction can be specified, the other one can be specified.

The imaging condition of the first field is the imaging direction, and the imaging condition of the second field is the imaging position. Therefore, the imaging position can be specified from the imaging direction. For example, when the imaging direction (vertical gradient) is “horizontal” in the case in which the coordinated imaging scene is “1”, the imaging position “front side of ball” can be specified through the task of the identification number (11) according to the imaging direction.

The imaging condition of the first field is the imaging state, which is detected by the imaging state sensor 18, and the imaging condition of the second field is the other imaging state excluding the imaging state detected by the imaging state sensor 18. Therefore, the imaging state thereof can be specified without providing a dedicated sensor for detecting the other imaging state. For example, even when a positioning sensor (GPS) for detecting the imaging position is not provided, the imaging position can be specified from the imaging state (for example, imaging method) detected by the imaging state sensor 18. Therefore, even with radio-wave disturbance or in a radio-wave unreachable environment, the imaging position can be specified.

The imaging condition of the first field is the imaging state related to the installation of its own camera, and the imaging condition of the second field is the imaging parameters which are set corresponding to the task of its own camera. Therefore, the imaging terminal 1A can set the imaging parameters suitable for the installation state of its own camera and capture images.

The task table 13C defines the imaging conditions and the processing conditions “display position” and “display method” other than the imaging conditions for each of the plurality of tasks related to image capturing, and the imaging terminal 1A is configured to specify the task of its own camera and specify the processing conditions other than the imaging conditions based on the specified task. Therefore, the processing conditions other than the imaging conditions can be specified from the imaging conditions, and the operation control of the processing conditions can be performed.

The imaging conditions with respect to the task show the imaging direction of its own camera, and the operation control can be performed by specifying the processing conditions other than the imaging direction.

The processing conditions other than the imaging conditions show the “display position” and “display method” of the images captured in accordance with the specified task. Since the image display has been configured to be controlled in accordance with the “display position” and “display method”, display suitable for the task can be controlled.

The task table 13C defines the tasks separately by coordinated imaging scenes. When the coordinated imaging scene is selected by the operation terminal 1B, the imaging terminal 1A specifies the task of its own camera from among the plurality of tasks defined corresponding to the coordinated imaging scenes. Therefore, the tasks which are different respectively in the coordinated imaging scenes can be specified.

Based on the specified task, the imaging terminal 1A instructs its own camera to perform the operation control of the contents corresponding to the task. Therefore, the imaging terminal 1A can set the imaging parameters corresponding to the task of its own camera, instruct image capturing thereof, and instruct the processing conditions (display position, display method) other than the imaging conditions with respect to the operation terminal 1B.

In the first embodiment, the imaging condition of the first field is the imaging direction, and the imaging condition of the second field is the imaging position. However, reversely, the imaging condition of the first field may be the imaging position, and the imaging condition of the second field may be the imaging method. By this configuration, the imaging method can be specified from the imaging position.

### Second Embodiment

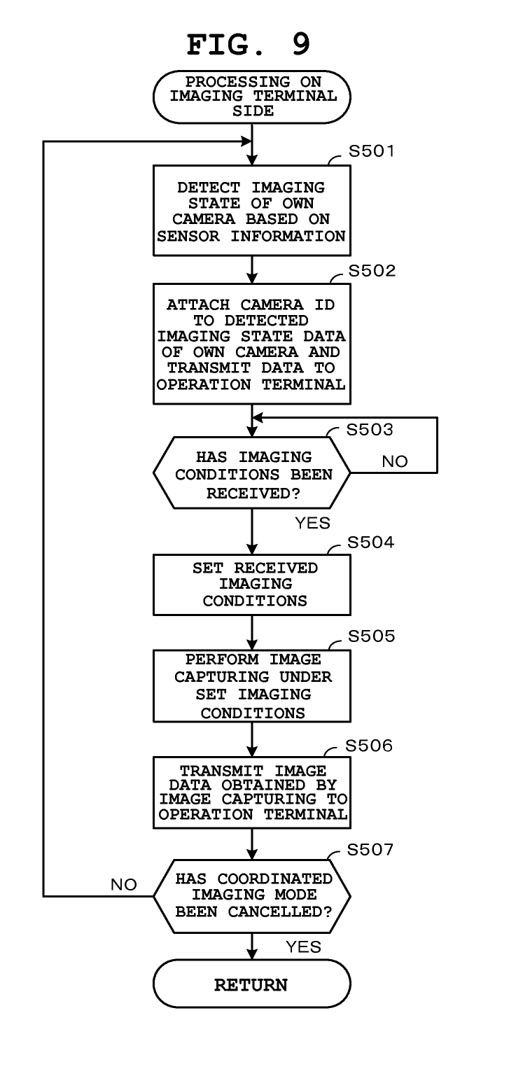

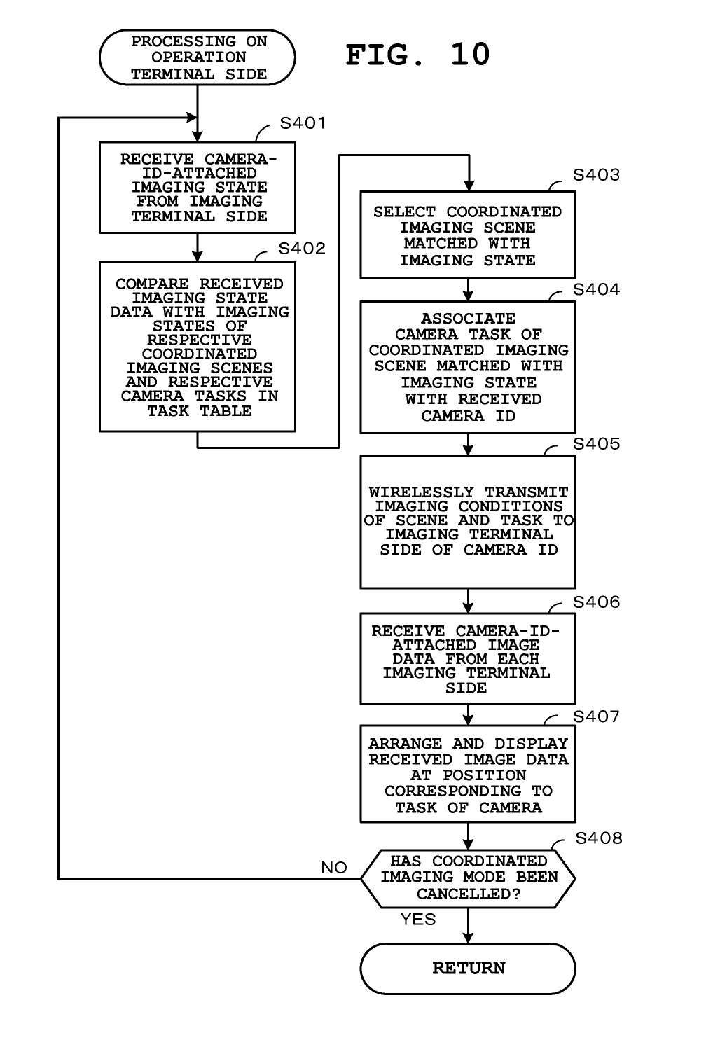

Hereafter, a second embodiment of the present invention is described with reference to FIG. 9 and FIG. 10.

In the above described first embodiment, the imaging terminal 1A serving as a camera controlling apparatus is configured to specify the imaging conditions of its own camera, specify the task of its own camera from among the plurality of tasks defined in the task table 13C based on the imaging conditions, specify the imaging parameters suitable for the task, and set them for its own camera. However, in this second embodiment, the operation terminal 1B is configured to control the operations of the imaging terminals 1A. More specifically, the first embodiment describes the case in which the imaging terminal 1A serving as the camera controlling apparatus controls itself. However, the operation terminal 1B of the second embodiment is configured to function as another camera controlling apparatus via wireless communication, in other words, a camera controlling apparatus which controls the operations of the imaging terminals 1A, receive and acquire the imaging conditions from the imaging terminals 1A, specify the tasks of the imaging terminals 1A, specify the imaging parameters suitable for the tasks, and transmit them to the imaging terminals 1A.

In the first embodiment, the task tables 13C are provided in the imaging terminals 1A and the operation terminal 1B, respectively. However, in the second embodiment, this task table 13C is provided only in the operation terminal 1B (camera controlling apparatus). Furthermore, the operation terminal 1B of the first embodiment exemplifies the case in which the “coordinated imaging scenes” are selected by user operations. However, in the second embodiment, the operation terminal 1B is configured to automatically select “coordinated imaging scenes” based on the imaging conditions of the imaging terminals 1A. Note that sections that are basically the same or have the same name in both embodiments are given the same reference numerals, and therefore explanations thereof are omitted. Hereafter, the characteristic portions of the second embodiment will mainly be described.

FIG. 9 is a flowchart for describing details of Step S5 (the processing on the imaging terminal side) of FIG. 5 in the second embodiment.

First, the imaging terminal 1A detects the installation state (imaging state) thereof as the imaging conditions of its own camera based on the sensor information (detection results of the acceleration sensor, electronic compass, and altimeter) obtained by the imaging state sensor 18 of its own camera in the coordinated imaging mode (Step S501), attaches its own camera ID (identification information) to the detected imaging state data (data in which the plurality of fields are combined) of its own camera, wirelessly transmits the data to the operation terminal 1B (Step S502), and enters a standby state until imaging conditions are received from the operation terminal 1B (Step S503).

FIG. 10 is a flowchart for describing details of Step S4 (the processing on the operation terminal side) of FIG. 5 in the second embodiment.

First, when the operation terminal 1B receives the imaging state data to which the camera ID has been attached, from the imaging terminal 1A (Step S401), and compares the received imaging state data with the “installation states (imaging states)” of the respective “camera tasks” corresponding to various “coordinated imaging scenes” in the task table 13C (Step S402). In this case, the operation terminal 1B sequentially compares the combinations of the “imaging directions (vertical gradients)”, “imaging directions (orientations)”, and “imaging heights” of the “installation states (imaging states)” defined in the task table 13C for the respective “coordinated imaging scenes” and the respective “camera tasks” with the combination of the received imaging state data so as to search for the “installation state (imaging state)” with which the imaging state matches (all fields match).

If the “installation state (imaging state)” matched with the imaging state can be searched as a result, the operation terminal 1B selects the “coordinated imaging scene” associated with the “installation state (imaging state)” (Step S403), specifies the “camera task” matched with the imaging state, and associates the “camera task” with the received camera ID (Step S404). Then, the operation terminal 1B reads out the imaging parameters (setting conditions) associated with the “coordinated imaging scene” and “camera task” matched with the imaging state, sets the imaging parameters, and instructs to perform image capturing by wireless transmission to the imaging terminal 1A of the received camera ID (Step S405).

When the “imaging parameters (setting conditions)” is received from the operation terminal 1B (YES at Step S503 of FIG. 9), the imaging terminal 1A sets the received “imaging parameters (setting conditions)” (Step S504) and then starts image capturing in accordance with the imaging parameters (Step S505). Subsequently, the imaging terminal 1A attaches its own camera ID to image data captured thereby, and wirelessly transmits it to the operation terminal 1B (Step S506). Then, the imaging terminal 1A judges whether the coordinated imaging mode has been cancelled and the termination of the coordinated image capturing has been instructed (Step S507). Here, until the termination is instructed, the imaging terminal 1A repeatedly returns to the above-described Step S501 and performs the above-described operations.

When the operation terminal 1B receives the camera-ID-attached image data from the imaging terminal 1A (Step S406 of FIG. 10), the operation terminal 1B displays the received image data by the terminal screen thereof. In this process, the operation terminal 1B reads out the “processing conditions other than imaging conditions” in the task table 13C based on the task associated with the camera ID and parallelly displays the image(s) in accordance with the “display position” and “display method” thereof (Step S407). In this case, display processing similar to that of the display examples of FIGS. 8A to 8D may be performed. Then, the operation terminal 1B judges whether the coordinated imaging mode has been cancelled and the termination of the coordinated image capturing has been instructed (Step S408). Here, until the termination is instructed, the operation terminal 1B repeatedly returns to the above-described Step S401 and performs the above-described operations.

As described above, in the second embodiment, when the operation of each of the role cameras (imaging terminals 1A) which take any of the plurality of tasks related to image capturing is to be controlled via wireless communication, the operation terminal 1B specifies the task of the imaging terminal 1A from among the plurality of tasks defined in the task table 13C, based on the imaging conditions received and acquired from the imaging terminal 1A. Therefore, even when the imaging conditions of the role camera (imaging terminal 1A) are changed, the task related to image capturing can be adapted to the changed imaging conditions without requiring any particular operation, and operation control corresponding to the task can be realized, as in the case of the first embodiment. In this case, the operation terminal 1B can manage the task of each of the imaging terminals 1A. More specifically, the operation terminal 1B can set the imaging parameters corresponding to the task of each of the imaging terminals 1A and instruct the imaging terminal 1A to capture an image(s) thereof, or can control the display position(s) and the display method of the image(s) as the processing conditions other than the imaging conditions.

In the above-described second embodiment, the camera apparatus 1 has been exemplified as the operation terminal (camera controlling apparatus). However, a PC (personal computer) such as a tablet terminal, a PDA (personal portable information communication device), a portable phone such as a smartphone may be used as the operation terminal (camera controlling apparatus). In this case, a configuration may be adopted in which a camera controlling mode for controlling coordinated image capturing is provided in a camera controlling apparatus such as a tablet terminal and, when the current mode is switched to this camera controlling mode, the operation of FIG. 10 is performed. Also, the communication means between the camera controlling apparatus and the camera apparatuses 1 may be optical communication, wired connections, or the like.

Also, in the above described embodiments, the imaging direction, the imaging height, etc. are detected by the imaging state sensor 18 provided in the imaging terminal 1A in the state in which the imaging terminal 1A has been attached to a fixing equipment such as a tripod (illustration omitted). However, a configuration may be adopted in which the imaging state sensor is provided in the fixing equipment side, and the installation state (imaging state) detected by the fixing equipment side is transmitted to the camera apparatus 1 when the camera apparatus 1 is attached thereto.

Moreover, in the above-described embodiments, the digital cameras have been exemplarily given as the imaging terminals 1A. However, they may be camera-equipped PDAs, portable phones such as smartphones, electronic games, etc. Moreover, the camera system is not limited to a golf-swing analyzing system, and may be a monitoring camera system which monitors people, facilities, etc.

Furthermore, the “apparatus” or the “sections” described in the above-described embodiment are not required to be in a single housing and may be separated into a plurality of housings by function. In addition, the steps in the above-described flowcharts are not required to be processed in time-series, and may be processed in parallel, or individually and independently.

Still further, in the above-described embodiment, the control section 11 is operated based on the programs stored in the storage section 13, whereby various types of functions (processing or sections) required to achieve the various types of effects described above are partially or entirely actualized (performed or configured). However, this is merely an example and other various methods can be used to actualize these functions.

For example, these various functions may be partially or entirely actualized by an electronic circuit, such as an IC (Input Circuit) or a LSI (Large-Scale Integration). Note that specific examples of the configuration of this electronic circuit are not described herein because a person ordinarily skilled in the art of the invention can easily actualize this configuration based on the flowcharts and the functional block diagrams described in the specification (For example, judgment processing accompanied by branch processing in the flowcharts can be configured by input date being compared by a comparator and a selector being switched by the comparison result).

Also, the plural functions (processing or sections) required to achieve the various effects can be freely divided. The following are examples thereof.

(Configuration 1)

A configuration including a defining section which defines mutually different imaging conditions in advance for a plurality of tasks related to image capturing; a first specifying section which specifies an imaging condition of a role camera serving as a candidate to take one of the plurality of tasks; and a second specifying section which specifies a task of the role camera from among the plurality of tasks defined by the defining section, based on the imaging condition specified by the first specifying section.

(Configuration 2)

The above-described configuration 1, in which the camera controlling apparatus is a camera having an imaging function, the plurality of tasks related to image capturing are tasks that are allocated to cameras when a plurality of cameras including an own camera are coordinated to perform image capturing, the first specifying section specifies an imaging condition of the own camera with the own camera as the role camera, and the second specifying section specifies a task of the own camera from among the plurality of tasks, based on the imaging condition specified by the first specifying section.

(Configuration 3)

The above-described configuration 1, in which the defining section defines mutually different combinations of imaging conditions of a first field and imaging conditions of a second field in advance for each of the plurality of tasks related to image capturing, the first specifying section specifies an imaging condition of the first field of the role camera, and the second specifying section specifies the task of the role camera from among the plurality of tasks defined by the defining section, based on the imaging condition of the first field specified by the first specifying section, and then specifies an imaging condition of the second field corresponding to the task of the role camera from among the imaging conditions of the second field defined by the defining section, based on the specified task.

(Configuration 4)

The above-described configuration 3, in which a relation between the imaging condition of the first field and the imaging condition of the second field is a relation between an imaging position and an imaging direction indicating an imaging state related to installation of the role camera.

(Configuration 5)

The above-described configuration 4, in which the imaging condition of the first field is the imaging direction, and the imaging condition of the second field is the imaging position.

(Configuration 6)

The above-described configuration 3, further including a detecting section which detects an imaging state, in which the imaging condition of the first field is the imaging state detected by the detecting section, and the imaging condition of the second field is an other imaging state excluding the imaging state detected by the detecting section.

(Configuration 7)

The above-described configuration 3, in which the imaging condition of the first field is an imaging state related to installation of the role camera, and the imaging condition of the second field is an imaging parameter that is set corresponding to the task of the role camera.

(Configuration 8)

The above-described configuration 1, in which the defining section defines mutually different combinations of the imaging conditions and processing conditions other than the imaging conditions in advance for the plurality of tasks related to image capturing, and the second specifying section specifies the task of the role camera, and then specifies a processing condition to be set for the role camera from among the processing conditions other than the imaging conditions defined by the defining section, based on the specified task.

(Configuration 9)

The above-described configuration 8, in which the imaging conditions include at least one of an imaging position and an imaging direction of the role camera.

(Configuration 10)

The above-described configuration 8, in which the processing conditions other than the imaging conditions include at least one of a display position and a display method for displaying images captured by a plurality of role cameras.

(Configuration 11)

The above-described configuration 1, further including a selecting section which selects, when a plurality of role cameras are to be coordinated to perform image capturing, one of a plurality of coordinated imaging scenes corresponding to tasks allocated to the role cameras, in which the second specifying section specifies the task of the role camera from among the plurality of tasks defined by the defining section to correspond to the coordinated imaging scene selected by the selecting section, based on the imaging condition specified by the first specifying section.

(Configuration 12)

The above-described configuration 1, further including an instructing section which instructs the role camera to perform operation control corresponding to the task, based on the task specified by the second specifying section.

(Configuration 13)

The above-described configuration 1, in which the first specifying section sequentially specifies imaging conditions of the role camera, and the second specifying section sequentially changes the task of the role camera based on the imaging conditions sequentially specified by the first specifying section.

(Configuration 14)

The above-described configuration 1, in which the camera controlling apparatus is a camera having an imaging function, the plurality of tasks related to image capturing are tasks that are allocated to a plurality of role cameras when the plurality of role cameras are coordinated to perform image capturing, the first specifying section specifies imaging conditions of the role cameras excluding an own camera, and the second specifying section specifies tasks of the role cameras from among the plurality of tasks, based on the imaging conditions of the role cameras specified by the first specifying section.

(Configuration 15)

A configuration of a camera controlling apparatus for controlling operation of each of role cameras taking one of a plurality of tasks related to image capturing via a communicating section, including an acquiring section which receives and acquires an imaging condition from each of the role cameras via the communicating section; a defining section which defines mutually different imaging conditions in advance for the plurality of tasks related to image capturing; and a specifying section which specifies a task of each of the role cameras from among the plurality of tasks defined by the defining section, based on the imaging condition of each of the role cameras received and acquired by the acquiring section.

(Configuration 16)

The above-described configuration 15, further including an instructing section which instructs the role camera to perform operation control corresponding to the task, based on the task specified by the specifying section.

(Configuration 17)

A configuration in a camera controlling method for a camera controlling apparatus, including a step of specifying an imaging condition of a role camera serving as a candidate to take one of a plurality of tasks related to image capturing; and a step of specifying a task of the role camera from among the plurality of tasks defined, based on the imaging condition specified with mutually different imaging conditions being defined in advance for each of the plurality of tasks.

While the present invention has been described with reference to the preferred embodiments, it is intended that the invention be not limited by any of the details of the description therein but includes all the embodiments which fall within the scope of the appended claims.

What is claimed is:

1. A camera controlling apparatus comprising:
a defining section which defines mutually different imaging conditions in advance for a plurality of tasks related to image capturing;
a first specifying section which specifies an imaging condition of a role camera serving as a candidate to take one of the plurality of tasks; and
a second specifying section which specifies a task of the role camera from among the plurality of tasks defined by the defining section, based on the imaging condition specified by the first specifying section.

2. The camera controlling apparatus according to claim 1, wherein the camera controlling apparatus is a camera having an imaging function,
wherein the plurality of tasks related to image capturing are tasks that are allocated to cameras when a plurality of cameras including an own camera are coordinated to perform image capturing,
wherein the first specifying section specifies an imaging condition of the own camera with the own camera as the role camera, and
wherein the second specifying section specifies a task of the own camera from among the plurality of tasks, based on the imaging condition specified by the first specifying section.

3. The camera controlling apparatus according to claim 1, wherein the defining section defines mutually different combinations of imaging conditions of a first field and imaging conditions of a second field in advance for each of the plurality of tasks related to image capturing,
wherein the first specifying section specifies an imaging condition of the first field of the role camera, and
wherein the second specifying section specifies the task of the role camera from among the plurality of tasks defined by the defining section, based on the imaging condition of the first field specified by the first specifying section, and then specifies an imaging condition of the second field corresponding to the task of the role camera from among the imaging conditions of the second field defined by the defining section, based on the specified task.

4. The camera controlling apparatus according to claim 3, wherein a relation between the imaging condition of the first field and the imaging condition of the second field is a relation between an imaging position and an imaging direction indicating an imaging state related to installation of the role camera.

5. The camera controlling apparatus according to claim 4, wherein the imaging condition of the first field is the imaging direction, and the imaging condition of the second field is the imaging position.

6. The camera controlling apparatus according to claim 3, further comprising:
a detecting section which detects an imaging state,
wherein the imaging condition of the first field is the imaging state detected by the detecting section, and
wherein the imaging condition of the second field is an other imaging state excluding the imaging state detected by the detecting section.

7. The camera controlling apparatus according to claim 3, wherein the imaging condition of the first field is an imaging state related to installation of the role camera, and
wherein the imaging condition of the second field is an imaging parameter that is set corresponding to the task of the role camera.

8. The camera controlling apparatus according to claim 1, wherein the defining section defines mutually different combinations of the imaging conditions and processing conditions other than the imaging conditions in advance for the plurality of tasks related to image capturing, and
wherein the second specifying section specifies the task of the role camera, and then specifies a processing condition to be set for the role camera from among the processing conditions other than the imaging conditions defined by the defining section, based on the specified task.

9. The camera controlling apparatus according to claim 8, wherein the imaging conditions include at least one of an imaging position and an imaging direction of the role camera.

10. The camera controlling apparatus according to claim 8, wherein the processing conditions other than the imaging conditions include at least one of a display position and a display method for displaying images captured by a plurality of role cameras.

11. The camera controlling apparatus according to claim 1, further comprising:
a selecting section which selects, when a plurality of role cameras are to be coordinated to perform image capturing, one of a plurality of coordinated imaging scenes corresponding to tasks allocated to the role cameras,
wherein the second specifying section specifies the task of the role camera from among the plurality of tasks defined by the defining section to correspond to the coordinated imaging scene selected by the selecting section, based on the imaging condition specified by the first specifying section.

12. The camera controlling apparatus according to claim 1, further comprising:
an instructing section which instructs the role camera to perform operation control corresponding to the task, based on the task specified by the second specifying section.

13. The camera controlling apparatus according to claim 1, wherein the first specifying section sequentially specifies imaging conditions of the role camera; and
wherein the second specifying section sequentially changes the task of the role camera based on the imaging conditions sequentially specified by the first specifying section.

14. The camera controlling apparatus according to claim 1, wherein the camera controlling apparatus is a camera having an imaging function,
wherein the plurality of tasks related to image capturing are tasks that are allocated to a plurality of role cameras when the plurality of role cameras are coordinated to perform image capturing,
wherein the first specifying section specifies imaging conditions of the role cameras excluding an own camera, and
wherein the second specifying section specifies tasks of the role cameras from among the plurality of tasks, based on the imaging conditions of the role cameras specified by the first specifying section.

15. A camera controlling apparatus for controlling operation of each of role cameras taking one of a plurality of tasks related to image capturing via a communicating section, comprising:
an acquiring section which receives and acquires an imaging condition from each of the role cameras via the communicating section;
a defining section which defines mutually different imaging conditions in advance for the plurality of tasks related to image capturing; and
a specifying section which specifies a task of each of the role cameras from among the plurality of tasks defined by the defining section, based on the imaging condition of each of the role cameras received and acquired by the acquiring section.

16. The camera controlling apparatus according to claim 15, further comprising:
an instructing section which instructs the role camera to perform operation control corresponding to the task, based on the task specified by the specifying section.

17. A camera controlling method for a camera controlling apparatus, comprising:
a step of specifying an imaging condition of a role camera serving as a candidate to take one of a plurality of tasks related to image capturing; and
a step of specifying a task of the role camera from among the plurality of tasks defined, based on the imaging condition specified with mutually different imaging conditions being defined in advance for each of the plurality of tasks.

18. A camera controlling method for controlling operation of each of role cameras taking one of a plurality of tasks related to image capturing via a communicating section, comprising:
a step of receiving and acquiring an imaging condition from each of the role cameras via the communicating section; and
a step of specifying a task of each of the role cameras from among the plurality of tasks defined, based on the imaging condition of each of the role cameras received and acquired with mutually different imaging conditions being defined in advance for the plurality of tasks related to image capturing.

19. A non-transitory computer-readable storage medium having a program stored thereon that is executable by a computer of a camera controlling apparatus to actualize functions comprising:
processing for specifying an imaging condition of a role camera taking one of a plurality of tasks related to image capturing; and
processing for specifying a task of the role camera from among the plurality of tasks defined, based on the imaging condition specified with mutually different imaging conditions being defined in advance for the plurality of tasks.
